(19) United States
(12) Patent Application Publication
(10) Pub. No.: US 2010/0063224 A1
(43) Pub. Date: Mar. 11, 2010

(54) APPARATUS AND METHOD FOR PRODUCING POLYOLEFIN

(75) Inventor: Hitoshi Kimoto, Sodegaura-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/554,701

(22) Filed: Sep. 4, 2009

(30) Foreign Application Priority Data
Sep. 8, 2008 (JP) 2008-229732

(51) Int. Cl. C08F 2/01; B01J 19/00

(52) U.S. Cl. 526/65; 422/134

(57) ABSTRACT

[Object]

An object of the present invention is to produce a polyolefin by efficiently reusing unreacted monomers at low costs.

[Solution to Problem]

A polymerization apparatus 1 of the present invention includes: a liquid-phase reactor 2 in which olefin monomers are subjected to liquid-phase polymerization; a vapor-phase reactor 3 in which olefin monomers are subjected to vapor-phase polymerization; a condenser 4 that condenses unreacted olefin monomers discharged from the vapor-phase reactor 3 so as to produce a liquid containing the olefin monomers; and a liquefied monomer transfer line 11 through which the liquid containing the olefin monomers is transferred from the condenser 4 into the liquid-phase reactor 2. Thus, collected unreacted monomers can be directly subjected to the liquid-phase polymerization without additionally requiring a process such as purification steps. Therefore, the unreacted olefin monomers can be reused efficiently and economically.

This Nonprovisional application claims priority under 35 U.S.C. §119(a) on Patent Application No. 2008-229732 filed in Japan on Sep. 8, 2008, the entire contents of which are hereby incorporated by reference.

### TECHNICAL FIELD

The present invention relates to an apparatus and a method for producing a polyolefin.

### BACKGROUND ART

A polyolefin production apparatus containing a vapor-phase reactor, generally includes a circulation line for returning unreacted olefin monomers to a reactor, so that the unreacted olefin monomers can be reused. For example, Patent Literature 1 discloses a continuous gas fluidized-bed method in which (i) a gas containing unreacted olefin monomers is taken out from a vapor-phase reactor, (ii) by use of a cyclone separator, fine particles, such as a polyolefin, are separated from the gas, (iii) the gas from which the fine particles have been separated is condensed so as to obtain a gas-liquid mixture, (iv) the gas-liquid mixture thus obtained is separated into a gas and a liquid, (iv) the gas thus separated is transferred back to a bottom section of the vapor-phase reactor, and (v) the liquid thus separated is directly introduced to a fluidized-bed of the vapor-phase reactor.

Further, Patent Literature 2 discloses a vapor-phase polymerization process in which (i) a gas containing unreacted olefin monomers is taken out from a vapor-phase reactor, (ii) polyolefin particles are separated from the gas, and then (iii) the gas from which the polyolefin particles have been separated is condensed so as to obtain olefin monomers, after that, (iv) the olefin monomers are purified and transferred back into the vapor-phase reactor so that the olefin monomers can be subjected to the reaction again.

### CITATION LIST

Patent Literature 1

JP 10-81702 A (Publication Date: Mar. 31, 1998)

Patent Literature 2

JP 2004-204028 A (Publication Date: Jul. 22, 2004)

### SUMMARY OF INVENTION

### Technical Problem

Meanwhile, in the production of a polyolefin, there has been demand for a further improvement in a technique for efficiently reusing unreacted olefin monomers at low costs for producing the polyolefin.

An object of the present invention is to provide an apparatus and a method for producing a polyolefin, which make it possible to efficiently reuse unreacted olefin monomers at low costs.

### Solution to Problem

A polyolefin production apparatus of the present invention includes: at least one liquid-phase reactor in each of which olefin monomers are subjected to liquid-phase polymerization; at least one vapor-phase reactor in each of which olefin monomers are subjected to vapor-phase polymerization; at least one condenser that condenses a gas containing olefin monomers so as to produce a liquid containing the olefin monomers; a first material transfer line through which one of the at least one liquid-phase reactor is connected to one of the at least one vapor-phase reactor; a second material transfer line through which the condenser is connected to any one of the at least one vapor-phase reactor; and a third material transfer line through which the condenser is connected to any one of the at least one liquid-phase reactor.

A polyolefin production method of the present invention, employing the apparatus described above includes the steps of: performing the liquid-phase polymerization of olefin monomers in the at least one liquid-phase reactor so as to produce a slurry containing a polyolefin; transferring the slurry containing the polyolefin, through the first material transfer line, from the liquid-phase reactor connected to the first material transfer line to the vapor-phase reactor connected to the first material line; performing the vapor-phase polymerization of olefin monomers in the at least one vapor-phase reactor so as to produce a polyolefin; introducing the gas containing olefin monomers discharged from the vapor-phase reactor connected to the condenser, into the condenser; partially or wholly condensing the gas in the condenser so as to produce liquid containing olefin monomers; and supplying the liquid into the liquid-phase reactor connected to the condenser so as to supply the liquid to the liquid-phase polymerization.

Further, in a polyolefin production apparatus of a preferable embodiment of the present invention, a plurality of liquid-phase reactors are connected in series.

In a polyolefin production apparatus of another preferable embodiment of the present invention, a plurality of vapor-phase reactors are connected in series.

Further, in a polyolefin production apparatus of still another preferable embodiment of the present invention, the condenser includes a heat exchanger through which a coolant flows.

Furthermore, in a polyolefin production apparatus of a further another preferable embodiment of the present invention, the condenser is provided with a mechanism for maintaining the amount of the liquid in the condenser at a certain amount.

Moreover, a polyolefin production apparatus of a still further preferable embodiment of the present invention, further includes a fourth material transfer line through which the condenser is connected to any one of the at least one vapor-phase reactor.

### Advantageous Effects of Invention

In accordance with the present invention, unreacted olefin monomers that are discharged from a vapor-phase reactor can be reused efficiently and economically in the production of a polyolefin.

### BRIEF DESCRIPTION OF DRAWINGS

FIG. 1

FIG. 1 is a block diagram illustrating the arrangement of a polymerization apparatus 1 in accordance with an embodiment of the present invention.

### DESCRIPTION OF EMBODIMENTS

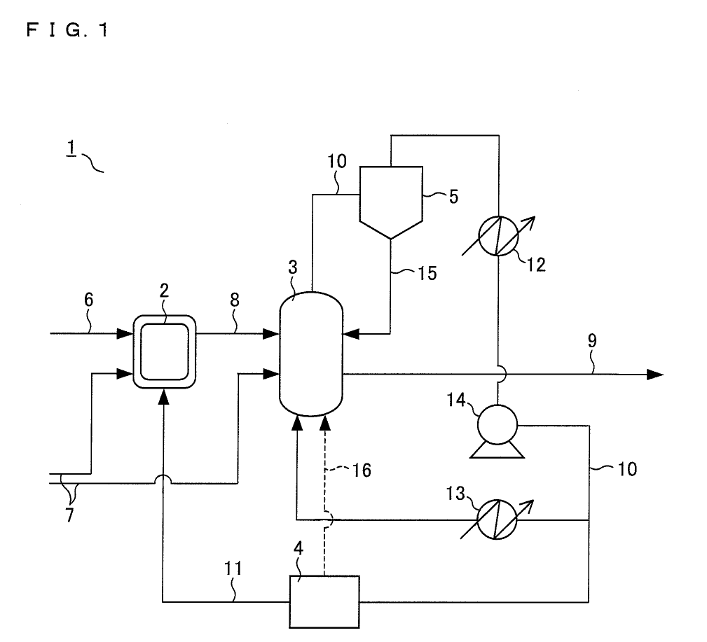

The following description explains a polymerization apparatus in accordance with an embodiment of the present invention with reference to FIG. 1. FIG. 1 is a block diagram illustrating the arrangement of a polymerization apparatus 1. As illustrated in FIG. 1, the polymerization apparatus 1 includes a liquid-phase reactor 2, a vapor-phase reactor 3, and a condenser 4. The polymerization apparatus 1 further includes a particle separator 5 in a second material transfer line which connects the vapor-phase reactor 3 and the condenser 4 to each other.

To the liquid-phase reactor 2, (i) a catalyst which is used for liquid-phase polymerization is provided through a catalyst supply line 6, and (ii) liquid olefin monomers are provided through a monomer supply line 7. The olefin monomers provided to the liquid-phase reactor 2 are subjected to liquid-phase polymerization, so that a slurry product containing polyolefin particles can be obtained.

Here, the catalyst provided to the liquid-phase reactor 2 may be a polymerization catalyst known for use in olefin polymerization. Examples of such a catalyst include: Ziegler-Natta catalysts (catalysts disclosed in JP 57-63310 A (1982), JP 58-83006 A (1983), JP 61-78803 A (1986), JP 07-216017 A (1995), JP 10-212319 A (1998), JP 62-158704 A (1987), and JP 11-92518 A (1999), for example); and metallocene catalysts (catalysts disclosed in JP 05-155930 A (1993), JP 09-143217 A (1997), JP 2002-293817 A, JP 2003-171412 A, WO 94/28034 A (1994), and JP 2001-31720 A, for example).

The Ziegler-Natta catalyst used in the present embodiment is preferably one obtained in such a manner that the following components (a) through (c) are mixed in contact with each other.
Component (a): a solid component containing titanium, magnesium, and halogen
Component (b): an organoaluminum compound
Component (c): an electron-donating compound

The solid component containing titanium, magnesium, and halogen (Component (a)) is preferably a solid component obtained in such a manner that (i) a solid component containing a magnesium atom, a titanium atom, and a hydrocarbon oxy group, (ii) a halogenated compound, and (iii) an electron donor and/or an organic acid halide, are mixed in contact with each other. Particularly, a solid component that contains a phthalic acid ester as the electron donor is more preferable.

The organoaluminum compound (Component (b)) is preferably, for example, trimethylaluminum, triethylaluminum, or triisobutylaluminum. Among them, triethylaluminum is particularly preferable.

Examples of the electron-donating compound (Compound (c)) include: tert-butyl-n-propyl dimethoxysilane; dicyclopentyldimethoxysilane; cyclohexylmethyldimethoxysilane; cyclohexylethyldimethoxysilane; and diethylaminotriethoxysilane.

Further, the olefin monomers provided to the liquid-phase reactor 2 may be, for example, a C₂₋₁₂ α-olefin, such as ethylene, propylene, or butene.

The slurry product obtained in the liquid-phase reactor 2 is transferred to the vapor-phase reactor 3 through a slurry transfer line 8. The slurry transfer line 8 corresponds to a first transfer line of the apparatus of the present invention. To the vapor-phase reactor 3, a gas containing olefin monomers is provided through the monomer supply line 7. The gas containing the olefin monomers may be a mixed gas containing ethane, propane, hydrogen, nitrogen, or the like, which is not polymerizable with the olefin monomers. Further, the mixed gas containing the olefin monomers is provided to the vapor-phase reactor 3 through a gas feeding nozzle (not illustrated). The mixed gas then flows through the vapor-phase reactor 3, and is discharged through a gas discharging nozzle (not illustrated) of the vapor-phase reactor 3. However, the mixed gas thus discharged may be returned to the vapor-phase reactor 3 through a circulation gas line 10. Further, the mixed gas containing the olefin monomers is partially discharged, together with the generated polyolefin particles, through a transfer line 9.

The slurry product provided to the vapor-phase reactor 3 contains: the catalyst which has been used in the liquid-phase reactor 2; the polyolefin particles obtained by the liquid-phase polymerization; and unreacted liquid olefin monomers. The unreacted liquid olefin monomers in the slurry product are vaporized in the vapor-phase reactor 3, thereby turning into an olefin monomer gas. Then, the unreacted liquid olefin monomers in the form of olefin monomer gas are utilized in the vapor-phase polymerization, so that the vapor-phase polymerization is carried out with (i) the unreacted liquid olefin monomers thus provided to the vapor-phase reactor 3 and (ii) the olefin monomers in the mixed gas provided to the vapor-phase reactor 3. As a result, it is possible to obtain further grown polyolefin particles.

Each of the polymerization of the olefin monomers in the liquid-phase reactor 2 and the polymerization of the olefin monomers in the vapor-phase reactor 3 can be carried out by adopting conventionally known reaction conditions. Particularly, in the vapor-phase reactor 3, it is possible to continuously polymerize olefin monomers by circulating the olefin monomers through a fluidized-bed under the presence of a polymerization catalyst. The catalysts used in the vapor-phase polymerization is the same as the catalyst provided to the liquid-phase reactor 2, for example.

Here, if the amount of the unreacted liquid olefin monomers in the slurry product provided to the vapor-phase reactor 3 becomes large excessively, the gas pressure in the vapor-phase reactor 3 varies due to the olefin monomer gas vaporized from the unreacted liquid olefin monomers. In order to avoid this, it is necessary to take out a portion of the gas. In the polymerization apparatus 1 of the present invention, (i) the olefin monomer gas in the gas taken out from the vapor-phase reactor 3 is liquefied in the condenser 4, thereby obtaining the olefin monomers in a liquid form, (ii) the olefin monomers in the liquid form thus obtained are transferred back to the liquid-phase reactor 2, and then reused for the liquid-phase polymerization. In other words, in the polymerization apparatus 1 of the present invention, the olefin monomers that are collected from a reaction system are reused in the same reaction system. The reuse of the olefin monomers thus collected does not additionally require a plurality of purification steps employing a special purification device. Therefore, it is possible to efficiently and economically reuse the olefin monomers collected from the reaction system.

The following description explains the reuse of the olefin monomers collected from the reaction system. First, a mixed gas containing polyolefin particles, a catalyst and unreacted olefin monomers is discharged from the vapor-phase reactor 3, and is transferred to the particle separator 5 through the circulation gas line 10. In the particle separator 5, the polyolefin particles and the catalyst are separated from the gas containing the unreacted olefin monomers, and a large portion of the polyolefin particles and a large portion of the catalyst are removed from the mixed gas. The polyolefin particles thus separated are transferred back to the vapor-phase reactor through a particle recycle line 15, and then are discharged through the transfer line 9. The particle recycle line 15 is a line for transferring the particles separated in the particle separator 5 to the vapor-phase reactor 3.

The mixed gas containing the unreacted olefin monomers resulting from the removal of a large portion of the polyolefin particles and a large portion of the catalyst by the particle separator 5 passes through the circulation gas line 10. During the passage through the circulation gas line 10, the mixed gas passes through a first circulation gas-cooling heat exchanger 12 and a compressor 14. Then, the mixed gas is transferred to the condenser 4. In the present embodiment, the circulation gas line 10, the first circulation gas-cooling heat exchanger 12, and the compressor 14 are included in a second material transfer line of the present invention. After being provided to the condenser 4, the mixed gas is condensed, thereby being liquefied to a liquid containing the olefin monomers, which are in the liquid form. The olefin monomers in the liquid form are transferred to the liquid-phase reactor 2 through a liquefied monomer transfer line 11, and then are reused for the liquid-phase polymerization. In the present embodiment, the liquefied monomer transfer line 11 corresponds to a third material transfer line of the present invention. It is preferable that the condenser 4 have a mechanism for maintaining the amount of the liquid in the condenser 4 at a certain amount. With such an arrangement that the liquid is transferred from the condenser 4 into the liquid-phase reactor 2 so that the amount of the liquid can be kept constant in the condenser 4, it is possible to continuously provide the liquid containing the olefin monomers from the condenser 4 to the liquid-phase reactor 2. Further, the mixed gas containing unreacted olefin monomers that have not been liquefied in the condenser 4 (hereinafter, referred to as “unliquefied monomers”) may be transferred back to the vapor-phase reactor 3, and reused for the vapor-phase polymerization. In order to transfer the unliquefied monomers back to the vapor-phase reactor 3, the condenser 4 may be connected to the vapor-phase reactor 3 by a fourth material transfer line. Alternatively, the unliquefied monomers may be transferred back to the vapor-phase reactor 3 through the circulation gas line 10. It should be noted that the unliquefied monomers may be transferred back to the vapor-phase reactor 3 via a second circulation gas-cooling heat exchanger 13. The fourth material transfer line corresponds to an unliquefied transfer line 16 indicated by a dashed line of FIG. 1.

Further, the condenser 4 generally includes a heat exchanger through which a coolant flows. In the condenser 4, it is preferable to obtain the liquid containing the unreacted olefin monomers by cooling the unreacted olefin monomers in the mixed gas down to such a temperature that the unreacted olefin monomers are condensed to liquefy through heat exchange between a coolant, such as water, and the mixed gas. The temperature at which the mixed gas containing the unreacted olefin monomers is liquefied through condensation varies with the composition and the pressure of the mixed gas. Generally, however, the mixed gas is cooled down to a temperature which is lower by 10° C. to 30° C. than the dew point of the mixed gas determined by the composition and the pressure of the mixed gas.

The embodiment illustrated in FIG. 1 explains arrangement in which a single liquid-phase reactor 2, a single vapor-phase reactor 3, and a single condenser 4 are provided. However, in other embodiments of the present invention, an apparatus of the present invention includes two or more liquid-phase reactors connected to each other in series. In such embodiments, one condenser may be connected with one, some, or all of the liquid-phase reactors. In other embodiments of the present invention, an apparatus of the present invention includes two or more vapor-phase reactors connected to each other in series. In such embodiments, one of the vapor-phase reactors may be provided with a condenser, or alternatively, two or more of the vapor-phase reactors each may be provided with a condenser. As a further alternative, all or some of the vapor-phase reactors may share a condenser.

By the use of the apparatus of the present invention, it is possible to efficiently produce a polyolefin.

A method of producing a polyolefin by employing the apparatus described above includes the steps of: in each of the at least one liquid-phase reactor, subjecting olefin monomers to liquid-phase polymerization so as to produce a slurry containing a polyolefin; transferring the slurry containing the polyolefin, through the first material transfer line, from the liquid-phase reactor connected to the first material transfer line to the vapor-phase reactor connected to the first material line; in each of the at least one vapor-phase reactor, subjecting olefin monomers to vapor-phase polymerization so as to produce a polyolefin; introducing a gas containing olefin monomers discharged from the vapor-phase reactor connected to the condenser into the condenser; in the condenser, partially or wholly condensing the gas so as to produce a liquid containing the olefin monomers which have been included in the gas; and supplying the liquid into the liquid-phase reactor connected to the condenser so as to subject the liquid to liquid-phase polymerization.

### Example

A mixed gas was discharged from a vapor-phase reactor 3, and then, a large portion of a catalyst and a large portion of polypropylene particles were removed from the mixed gas in a particle separator 5. The mixed gas was partially introduced into a condenser 4. In the condenser 4, the mixed gas was cooled down from 80° C. to 45° C. As a result, 62 wt % of the mixed gas introduced into the condenser 4 was liquefied, thereby yielding a liquid. The liquid was introduced into the liquid-phase reactor 2, so that it was used successfully for the liquid-phase polymerization. The remaining 38 wt % mixed gas, which had not been liquefied, was collected into a circulation gas line 10, and was introduced into the vapor-phase reactor 3. The mixed gas collected was supplied to the vapor-phase polymerization.

As described above, by partially liquefying the mixed gas and reusing the resulting liquid in the liquid-phase reactor 2, it was possible to carry out polymerization reaction without having an excess of propylene in the vapor-phase reactor 3.

### Comparative Example

A mixed gas was discharged from a vapor-phase reactor 3, and then a large portion of a catalyst and a large portion of polypropylene particles were removed from the mixed gas by a particle separator 5. After that, the mixed gas was not transferred to a condenser but transferred back to the vapor-phase reactor 3 through a circulation gas line 10. Then, the mixed gas was supplied to polymerization reaction. As a result, an excess of propylene was generated in the vapor-phase reactor 3. For this reason, it was necessary to have an additional purification step for reuse of the mixed gas.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

By the use of an apparatus of the present invention, it is possible to produce a polyolefin by reusing, efficiently and at low cost, unreacted olefin monomers that are discharged from a vapor-phase reactor. Therefore, the apparatus of the present invention is suitably applicable to a method of producing a polyolefin by employing multistep polymerization in which liquid-phase polymerization and vapor-phase polymerization are combined. For example, the apparatus of the present invention is suitably applicable to: a method of producing propylene homopolymers; a method of producing propylene-ethylene block copolymers; a method of producing propylene-ethylene random copolymers; and a method of producing propylene-ethylene-butene-1 copolymers.

### REFERENCE SIGNS LIST

1. POLYMERIZATION APPARATUS
2. LIQUID-PHASE REACTOR
3. VAPOR-PHASE REACTOR
4. CONDENSER
5. PARTICLE SEPARATOR
6. CATALYST SUPPLY LINE
7. MONOMER SUPPLY LINE
8. SLURRY TRANSFER LINE
9. TRANSFER LINE
10. CIRCULATION GAS LINE
11. LIQUEFIED MONOMER TRANSFER LINE
12. FIRST CIRCULATION GAS-COOLING HEAT EXCHANGER
13. SECOND CIRCULATION GAS-COOLING HEAT EXCHANGER
14. COMPRESSOR
15. PARTICLE RECYCLE LINE
16. UNLIQUEFIED MONOMER TRANSFER LINE

1. An apparatus for producing a polyolefin, comprising:
at least one liquid-phase reactor in each of which olefin monomers are subjected to liquid-phase polymerization;
at least one vapor-phase reactor in each of which olefin monomers are subjected to vapor-phase polymerization;
at least one condenser that condenses a gas containing olefin monomers so as to produce a liquid containing the olefin monomers;
a first material transfer line through which one of the at least one liquid-phase reactor is connected to one of the at least one vapor-phase reactor;
a second material transfer line through which the condenser is connected to any one of the at least one vapor-phase reactor; and
a third material transfer line through which the condenser is connected to any one of the at least one liquid-phase reactor.

2. The apparatus according to claim 1, wherein:
the at least one liquid-phase reactor comprises two or more liquid-phase reactors that are connected in series.

3. The apparatus according to claim 1, wherein:
the at least one vapor-phase reactor comprises two or more vapor-phase reactors that are connected in series.

4. The apparatus according to claim 2, wherein:
the at least one vapor-phase reactor comprises two or more vapor-phase reactors that are connected in series.

5. The apparatus according to claim 1, wherein:
the condenser includes a heat exchanger through which a coolant flows.

6. The apparatus according to claim 1, wherein:
the condenser is provided with a mechanism for maintaining the amount of the liquid in the condenser at a certain amount.

7. The apparatus according to claim 1, further comprising:
a fourth material transfer line through which the condenser is connected to any one of the at least one vapor-phase reactor.

8. A method of producing a polyolefin by employing an apparatus recited in claim 1, comprising the steps of:
performing the liquid-phase polymerization of the olefin monomers in the at least one liquid-phase reactor so as to produce a slurry containing a polyolefin;
transferring the slurry containing the polyolefin, through the first material transfer line, from the liquid-phase reactor connected to the first material transfer line to the vapor-phase reactor connected to the first material line;
performing the vapor-phase polymerization of the olefin monomers in the at least one vapor-phase reactor so as to produce a polyolefin;
introducing the gas containing olefin monomers discharged from the vapor-phase reactor connected to the condenser, into the condenser;
partially or wholly condensing the gas in the condenser so as to produce the liquid containing the olefin monomers; and
supplying the liquid into the liquid-phase reactor connected to the condenser so as to supply the liquid to the liquid-phase polymerization.
